(19) United States
(12) Patent Application Publication
(10) Pub. No.: US 2024/0003461 A1
(43) Pub. Date: Jan. 4, 2024

(54) ELECTROMAGNETIC ACTUATOR DEVICE, SOLENOID VALVE, AND METHOD FOR OPERATING THE ELECTROMAGNETIC ACTUATOR DEVICE

(71) Applicant: ETO MAGNETIC GmbH, Stockach (DE)

(72) Inventors: Oliver THODE, Stockach (DE); Jörg BÜRSSNER, Engen (DE); Viktor RAFF, Konstanz (DE); Jörg HEITMANN, Konstanz (DE)

(21) Appl. No.: 18/255,659

(22) PCT Filed: Dec. 3, 2021
(86) PCT No.: PCT/EP2021/084174

§ 371 Date: Jun. 2, 2023

(30) Foreign Application Priority Data
Dec. 4, 2020 (DE) 10 2020 132 351.4

(51) Int. Cl. F16K 31/06; H01F 7/08

(52) U.S. Cl. CPC F16K 31/0689; F16K 31/0655; H01F 2007/086; H01F 7/088; H01F 7/081

(57) ABSTRACT

An electromagnetic actuator device, in particular an electromagnetic valve device, has at least one magnet core element, has a magnet armature element, which is supported movably relative to the magnet core element and forms a receiving recess, and has a reset spring, which is configured to push the magnet core element and the magnet armature element away from one another, the magnet armature element having an application face, which is arranged inside the receiving recess and on which a first end of the reset spring is supported, wherein the electromagnetic actuator device comprises a damping element, which is arranged between the magnet core element and the magnet armature element and which forms a spring seat, on which a second end of the reset spring, lying opposite the first end, is supported.

### CROSS REFERENCE TO RELATED APPLICATIONS

This application is based on and incorporates herein by reference the German patent application DE 10 2020 132 351.4, filed on Dec. 4, 2020, and the international patent application PCT/EP2021/084174, filed on Dec. 3, 2021.

### PRIOR ART

The invention relates to an electromagnetic actuator device, to a solenoid valve, and to a method.

EP 2 630 647 A2 has already proposed an electromagnetic actuator having at least one magnet core element, having a magnet armature element, which is supported movably relative to the magnet core element and forms a receiving recess, and having a reset spring, which is configured to push the magnet core element and the magnet armature element away from one another, the magnet armature element having an application face, which is arranged inside the receiving recess and on which a first end of the reset spring is supported. Because an elastomeric damper, which cannot effectively conduct a magnetic field, is arranged in an outer diameter region of the magnet armature element in EP 2 630 647 A2, in order to increase a magnetic force provided by the actuator only a diameter of the reset spring may be reduced, which entails an increased susceptibility of the reset spring to kinking, and this can lead to undesired transverse mechanical forces that affect the service life.

The object of the invention, in particular, is to provide a device of the generic type having advantageous properties in respect of a magnetic field flux, particularly in respect of minimizing transverse forces. The object is achieved according to the invention.

### Advantages of the Invention

The invention is based on an electromagnetic actuator device, in particular an electromagnetic valve device, having at least one magnet core element, having a magnet armature element, which is supported movably relative to the magnet core element and forms a receiving recess, and having a reset spring, which is configured to push the magnet core element and the magnet armature element away from one another, particularly in the axial direction of the magnet armature element and/or of a magnet coil of the electromagnetic actuator device, the magnet armature element having an application face, which is arranged inside the receiving recess and on which a first end of the reset spring is supported.

In particular, “configured” means specially programmed, designed and/or equipped. That an object is configured for a particular function means, in particular, that the object fulfills and/or carries out this particular function in at least one application state and/or operation state.

It is proposed for the electromagnetic actuator device to have a damping element, which is arranged between the magnet core element and the magnet armature element and which forms a spring seat, on which a second end of the reset spring, lying opposite the first end, is supported. In this way, in particular, an advantageous magnetic flux may be achieved. Advantageously, a magnetic flux may be made possible in the outer diameter region of the magnet armature, in particular because the outer diameter region of the magnet armature can be realized so as to be free of a damping element. Advantageously, the actuator device has an outer diameter region of the magnet armature element and of the magnet core element, which is fully available for magnetic flux conduction. A relatively high magnetic force may advantageously be achieved in this way, particularly since a magnetic flux conduction increases with a greater outer diameter. In this way, particularly in comparison with EP 2 630 647 A2, the entire magnetic force may advantageously be increased substantially even with constant armature dimensions. Advantageously, a kink-resistant layout of the reset spring may be facilitated and/or made possible, in particular even when there are relatively high requirements for the magnetic forces to be achieved. Furthermore, shortening of the reset spring and/or a deeper arrangement of the reset spring in an interior of the receiving recess of the magnet armature element may advantageously be made possible. In this way, the reset spring may advantageously be placed in the magnet armature element in such a way that partial (mechanical) compensation for potentially occurring transverse (magnetic) forces may be achieved by the reset spring. Advantageously, particularly low tribological wear, and therefore in particular a long service life, may be achieved in this way.

An “electromagnetic actuator device” in this context means in particular an actuator device that can be driven by a magnet coil. In particular, the electromagnetic actuator device forms at least a portion, in particular a subassembly, of an electromagnetic actuator. Advantageously, the electromagnetic actuator device is configured at least for use in a valve, in particular a pneumatic switching valve and/or a (closed when de-energized) 2/2-way valve. In particular, because of the achieved minimization of the effect of transverse magnetic forces on the movement of the magnet armature element, the electromagnetic actuator device is particularly suitable for electromagnetic actuators with especially high requirements for energy efficiency and/or service life. In particular, the magnet core element forms at least a portion of a magnet core facing toward the magnet armature element. Preferably, the magnet core element entirely forms the magnet core. In particular, the magnet core element is immobile and/or stationary. Preferably, the magnet core element is arranged immovably and/or stationary relative to a housing of the electromagnetic actuator device and/or relative to a magnet coil of the electromagnetic actuator device. In particular, the magnet core element forms an inductor together with the magnet coil. Preferably, the magnet core element consists at least predominantly of a soft magnetic material having a high magnetic saturation flux density (for example >1 T) and having a high magnetic permeability (for example >3000). For example, the magnet core element consists at least predominantly of a soft iron and/or of an SiFe, NiFe, CoFe or AlFe alloy. In particular, the magnet armature element is configured to concentrate and guide the magnetic flux of the magnetic field coil.

Furthermore, a “magnet armature element” means a structural element which is configured, during operation of the electromagnetic actuator device, to execute a movement determined by the function of the actuator, for example a change of a valve setting. In particular, the magnet armature element forms at least a portion of the magnet armature facing toward the magnet core element. Preferably, the magnet armature element entirely forms the magnet armature. Preferably, the magnet armature element can be influenced by means of a magnetic signal, in particular a magnetic field. In particular, the magnet armature element is configured to perform a movement, in particular a linear movement, in response to a magnetic signal. In particular, the magnet armature element in this case consists at least partially of a magnetically active, in particular (ferro)magnetic and/or magnetizable material, advantageously iron and/or soft magnetic steel. In particular, the armature element forms a plunger armature or a plunger core of an actuator, in particular of a solenoid, which in particular is movable at least inside an interior of the magnet coil, in particular of the hollow coil. In particular, the magnet coil is configured to generate the magnetic field that is configured to interact with the armature element and/or accelerate the armature element in the direction of the axial direction of the magnet armature element, in particular the longitudinal midaxis of the magnet coil. In particular, the receiving recess is realized as an indentation and/or opening at least of the magnet armature element, which runs parallel to the axial direction of the magnet armature element. In particular, the receiving recess may have an alternating or variable diameter along the axial direction. In particular, the receiving recess is configured to receive further structural elements of the electromagnetic actuator device besides the reset spring, for example at least a portion of the damping element or at least a portion of a valve seat element. In particular, the receiving recess is arranged centrally in the magnet armature element. Preferably, the receiving recess is realized in the form of a tube or sleeve, for example as a bore, at least in a region in which the reset spring is arranged. In particular, the receiving recess comprises a reset spring receiving region, which preferably has a diameter that is matched to the outer diameter of the reset spring (for example at most 5% greater). In particular, the receiving recess comprises the application face, which forms a spring seat lying in an interior of the magnet armature element. In particular, the spring seat arranged in the interior of the magnet armature element is realized integrally, preferably monolithically, with the magnet armature element. In particular, the application face for the reset spring forms a spring seat of the magnet armature element.

In particular, the reset spring is embodied as a helical spring, preferably a helical compression spring. In particular, the reset spring is braced between the spring seat of the magnet armature element and the spring seat of the damping element. Preferably, the reset spring is in a preloaded state in all operation states of the electromagnetic actuator device. In particular, an operation state of the electromagnetic actuator device, in which the valve seat element rests on a valve seat, represents the operation state in which the reset spring is maximally relaxed. In particular, an operation state of the electromagnetic actuator device, in which the magnet armature element bears on a damping element, represents the operation state in which the reset spring is maximally loaded. The damping element is, in particular, arranged between the magnet core element and the magnet armature element in the axial direction of the magnet armature element. The damping element is, in particular, configured to prevent touching between the magnet armature element and the magnet core element in the axial direction of the magnet armature element. The damping element is, in particular, configured to prevent metallic abutments between the magnet armature element and the magnet core element. The damping element has, in particular, a modulus of elasticity (at 20° C.) of less than 10 GPa, preferably less than 5 GPa and preferentially less than 2 GPa, at least in a subregion facing toward the magnet armature element. The damping element preferably has a continuous recess, in particular bore. The continuous recess is preferably arranged centrally in the damping element.

In particular, the electromagnetic actuator device comprises a control cone, such as is already known for example from DE 198 48 919 A1 or from EP 2 630 647 A2. The control cone is configured to generate an at least partial overlap of the magnet armature element and the magnet core element during a movement of the magnet armature element. The control cone preferably comprises a first control cone part, assigned to the magnet core element, which is embodied as an elevation, in particular an annular elevation, protruding from a side of the magnet core element facing toward the magnet armature element. The control cone preferably comprises a second control cone part, assigned to the magnet armature element, which is realized as a recess extended in the axial direction in the magnet armature element, which preferably also forms a portion of the receiving recess. In particular, it is conceivable that the assignment of the control cone parts to the magnet armature element and magnet core element could also be reversed. The first control cone part is, in particular, configured to engage at least partially in the second control cone part during an actuation movement of the magnet armature. Preferably, side faces of the overlapping control cone parts are in this case angled relative to the axial direction, preferentially in mutually opposite directions. In this way, transverse magnetic forces occurring during the actuation movement of the magnet armature element, which may lead to an undesired rotational movement of the magnet armature element, may advantageously be substantially reduced.

It is furthermore proposed for the reset spring to have a diameter-length ratio of at least 0.35, preferably at least 0.4 and preferentially at least 0.45, a diameter relevant for calculating the diameter-length ratio being formed from an average value of an outer diameter of the reset spring and an inner diameter of the reset spring, and a length relevant for ascertaining the diameter-length ratio preferably being a length of the reset spring in a state of the reset spring when assembled, in particular preloaded, in the actuator device, preferentially in the state of the reset spring when assembled in the actuator device, in which a valve seat element of the magnet armature element is seated on a valve seat of a solenoid valve that the actuator device comprises (cf. also FIG. 1). In this way, a high kink resistance of the spring may advantageously be ensured, so that in particular low bearing forces and low tribological wear, which in the case of a reset spring that is not kink-resistant may occur for example due to tilting of the magnet armature element from a placement parallel to the axial direction of the magnet coil, may be achieved. Preferentially, the diameter-length ratio of the reset spring is at most 1.0. In particular, the receiving recess has a transverse extent, in particular a minimum transverse extent, perpendicularly to the axial direction which is at least 30%, preferably at least 35%, preferentially at least 40% and particularly preferentially at most 50% of a maximum transverse extent of the magnet armature element. In particular, the reset spring has a kink-resistant diameter-length ratio of at least 0.35.

It is also proposed for a quotient, which is formed from a difference between the outer diameter of the reset spring and the inner diameter of the reset spring and from a length of the reset spring, to be more than 0.85, preferably more than 1.0 and preferentially more than 1.1, the length relevant for ascertaining the quotient preferably being the length of the reset spring in the state of the reset spring when assembled, in particular preloaded, in the actuator device, preferentially in the state of the reset spring when assembled in the actuator device, in which a valve seat element of the magnet armature element is seated on a valve seat of a solenoid valve that the actuator device comprises (cf. also FIG. 1). In this way, a high kink resistance of the spring may advantageously be ensured, so that in particular low reaction forces and low tribological wear may be achieved. Preferentially, the quotient is at most 2.0. In particular, the reset spring is mostly formed from a steel wire. Preferably, the reset spring is at least mostly formed from a wire material having a wire thickness of at least 1 mm, preferably at least 1.2 mm and preferentially at most 2 mm. Mostly means in particular at least 66%, preferably at least 80% and preferentially at least 95%. In particular, the kink-resistant reset spring has a diameter-length ratio of at least 0.35 with a wire thickness of at least 1 mm.

Furthermore, it is proposed for the damping element to be arranged in a central region of the magnet armature element and/or of the magnet core element, said central region lying radially inward as seen relative to the axial direction of the magnet armature element and/or the magnet core element, in particular as seen relative to a central axis of the electromagnetic actuator device. In this way, in particular, an advantageous magnetic flux may be achieved. Advantageously, a magnetic flux in the outer diameter region of the magnet armature may be made possible, in particular because the outer diameter region of the magnet core can be realized so as to be free of a damping element. In particular, the central region of the magnet armature element and/or of the magnet core element, lying radially inward, extends over at least 25%, preferably at least 33%, advantageously at least 40%, preferentially at least 50% and particularly preferentially at most 66% of an entire, in particular a minimum, radial extent of the magnet armature element and/or of the magnet core element.

If the damping element, particularly in all possible operation states of the magnet armature element, is arranged at least partially in the receiving recess, a particularly deep-lying spring seat, in particular sunk a particularly long way into the magnet armature element, assigned to the damping element may be achieved. In this way, a particularly stabilizing effect of the reset spring against tilting of the magnet armature element may advantageously be achieved. In particular, at least a portion of the damping element is arranged in the reset spring receiving region of the receiving recess at least in one operation state of the magnet armature element. In particular, at least one part, in particular a further part, of the damping element is arranged in a region of the receiving recess different to the reset spring receiving region of the receiving recess in at least one operation state of the magnet armature element, preferably in all possible operation states of the magnet armature element.

It is additionally proposed for the damping element to be movable inside the receiving recess, in particular relative to the magnet armature element. In this way, in particular, advantageous damping may be achieved. Preferably, a maximum outer radius of the damping element is less than a minimum inner radius of the region of the receiving recess which is configured for at least partially receiving the damping element and which is different to the reset spring receiving region. In particular, the damping element is movable along the axial direction relative to the magnet armature element. In particular, the damping element is arranged at least substantially immovably relative to the magnet core element. In particular, the magnet armature element is movable relative to the damping element, the receiving recess being drawn toward the magnet core element, in particular partially over the damping element, during a movement of the magnet armature element.

Furthermore, it is proposed for the magnet core element to have a further receiving recess, which is configured to receive the damping element in such a way that it is at least substantially secured against radial movements. In this way, damping may advantageously be optimized, in particular because exact centering of the damping element around the axial direction can be achieved and/or because rocking of the damping element in the radial direction can be prevented. In particular, the radial direction runs perpendicularly to the axial direction through the axial direction. In particular, the damping element is fitted into the further receiving recess by means of a snug fit or by means of a light press fit. That the damping element “is substantially secured against radial movements” means in particular that a radial play of the damping element relative to the magnet core element is less than 1% of a maximum diameter of the damping element in the radial direction.

It is also proposed for the spring seat of the damping element to be arranged, as seen from the magnet core element in the axial direction (of the magnet core element and/or of the magnet armature element), below an end of the magnet armature element facing toward the magnet core element, particularly in an operation state of the magnet armature element in which the restoring element is maximally relaxed, preferably in all operation states of the magnet armature element. In this way, a particularly deep-lying spring seat, in particular sunk a particularly long way into the magnet armature element, assigned to the damping element may be achieved. In this way, a particularly stabilizing effect of the reset spring against tilting of the magnet armature element may advantageously be achieved. In particular, only states in which the electromagnetic actuator device is fully assembled and ready for use, form operation states of the magnet armature element. In particular, the spring seat of the damping element, particularly in an operation state of the magnet armature element in which the restoring element is maximally relaxed, preferably in all operation states of the magnet armature element, is sunk into the magnet armature element by a distance in the axial direction which is at least 3%, preferably at least 5%, preferentially 7% and particularly preferentially at most 25% of a total longitudinal extent of the magnet armature element in the axial direction. In particular, the spring seat of the damping element, particularly in an operation state of the magnet armature element in which the restoring element is maximally relaxed, preferably in all operation states of the magnet armature element, is sunk into the magnet armature element by a distance in the axial direction which is at least 8%, preferably at least 10%, preferentially 13% and particularly preferentially at most 33% of a total transverse extent of the magnet armature element running perpendicularly to the axial direction.

It is furthermore proposed for the damping element to be formed at least partially from an elastomer. In this way, advantageous damping properties may be achieved. For example, the elastomer is implemented as a vulcanizate of a natural rubber or as a vulcanizate of a silicone rubber. Preferentially, the elastomer is implemented as a synthetic rubber (for example SBR, BR, NBR, CR, SI, EPDM, or the like).

It is also proposed for the damping element to be realized as a multi-piece structural element having at least two components or as a composite structural element having at least two components, a first component of the multi-piece structural element or of the composite structural element being formed from the elastomer and being arranged at least partially on a region, in particular an outer region, of the damping element facing toward an abutment face of the magnet armature element. In this way, particularly good damping properties may advantageously be achieved. The at least two components of the multi-piece structural element may be adhesively bonded, welded, pressed, molded or otherwise connected to one another. Alternatively, however, the two components of the multi-piece structural element may also be free of a firm connection to one another, for example merely arranged next to one another, in particular arranged over one another or stacked on top of one another. The composite structural element is preferably produced by means of a multi-component injection molding method. Alternatively, however, the damping element may of course also be formed entirely from only a single component, for example from an elastomer.

If, in addition, a second component of the damping element, which is realized as a multi-piece structural element or as a composite structural element, is formed from a material that is substantially harder than the elastomer of the first component and is arranged at least partially in a region of the damping element around the spring seat for the reset spring, in particular on a side of the damping element facing toward the reset spring, a secure and firm spring seat may advantageously be provided together with good damping properties by the damping element. In particular, the second component is formed from a metal, for example aluminum, or from a hard plastic. In particular, the second component forms the spring seat. In particular, the damping element has a spring guiding element. In particular, the spring guiding element is configured to prevent slipping, in particular radial slipping, of the reset spring relative to the damping element. In particular, the spring seat of the damping element is arranged around the spring guiding element. In particular, in the assembled state of the electromagnetic actuator device, the spring guiding element engages at least partially in an interior of the reset spring that is embodied as a helical compression spring. In particular, in the assembled state of the electromagnetic actuator device, a portion of the reset spring is wound around the spring guiding element. In particular, the material of the second component has a modulus of elasticity (at 20° C.) of more than 5 GPa, advantageously more than 10 GPa, preferably more than 40 GPa and preferentially more than 69 GPa. Alternatively, the first component could also be arranged on a side of the damping element facing toward the magnet armature element while the second component is arranged on a side of the damping element facing toward the magnet armature element.

It is additionally proposed for a portion of the magnet armature element lying radially outward, particularly in the radial direction, which in particular extends over at least 20%, preferably at least 30% and preferentially at least 35% of a total radial extent of the magnet armature element, to be free of covering elements, such as damping elements, on at least one side facing toward the magnet core element. In this way, in particular, an advantageous magnetic flux may be achieved. Advantageously, a magnetic flux in the outer diameter region of the magnet armature may be made possible. In this way, a relatively high magnetic force of the electromagnetic actuator device may be achieved, in particular since the magnetic flux conduction increases with a greater outer diameter. Preferably, an intermediate space between the parts of the magnet armature element and of the magnet core element which lie outward radially, particularly in the radial direction, and face toward one another is free of elements or structural elements that substantially affect or hinder magnetic field guiding. Preferably, the intermediate space between the parts of the magnet armature element and of the magnet core element which lie outward radially, particularly in the radial direction, and face toward one another is with filled with a gas, for example filled with air, or evacuated.

Furthermore, it is proposed for at least a large portion of an overlap section of the magnet armature element, which is configured to enclose at least a portion of the magnet core element in the radial direction in at least one operation state of the magnet armature element, to be free of covering elements, such as damping elements, on at least one side facing toward the magnet core element. In this way, in particular, an advantageous magnetic flux may be achieved.

Furthermore, in one aspect of the invention, which may be considered independently or in combination with at least one, particularly in combination with one, particularly in combination with arbitrarily many of the other aspects of the invention, it is proposed for the reset spring to be arranged fully inside the receiving recess of the magnet armature element at least in the operation state of the magnet armature element in which the reset spring is maximally relaxed, preferably in all operation states of the magnet armature element. In this way, a particularly stabilizing effect of the reset spring against tilting of the magnet armature element may advantageously be achieved. In particular, the second end of the reset spring is arranged below an end of the magnet armature element facing toward the magnet core element, in particular below an end face of the magnet armature element facing toward the magnet core element, in the axial direction of the magnet armature element, in particular as seen from the magnet core element. In particular, the spring seat of the damping element and the spring seat of the magnet armature element are arranged inside the receiving recess of the magnet armature element.

In another aspect of the invention, which may be considered independently or in combination with at least one, particularly in combination with one, particularly in combination with arbitrarily many of the other aspects of the invention, it is also proposed for the application face for the reset spring, in particular the spring seat formed by the magnet armature element inside the receiving recess for the first end of the reset spring, to run and/or be arranged through the theoretical armature rotation point of the magnet armature element or, as seen from the magnet core element, to run and/or be arranged below the theoretical armature rotation point of the magnet armature element. In this way, a particularly stabilizing effect of the reset spring against tilting of the magnet armature element may advantageously be achieved. The theoretical armature rotation point is formed by a midpoint of two diametrically opposite outermost contact points of the magnet armature element, the outermost contact points being realized as the surface points of the magnet armature element at which the magnet armature element first touches an imaginary or real magnet armature guide enclosing the magnet armature element in the circumferential direction, in particular cylindrically, for example a pole tube of the electromagnetic actuator device, when the magnet armature element is rotated from a position in which an axial direction of the magnet armature element and an intended actuation direction of the magnet armature element run parallel, and in particular it is rotated about a rotation axis running perpendicularly to the intended actuation direction of the magnet armature element and/or to an axial direction of the magnet coil.

Alternatively or additionally, in another aspect of the invention, which may be considered independently or in combination with at least one, particularly in combination with one, particularly in combination with arbitrarily many of the other aspects of the invention, it is proposed for the application face for the reset spring, in particular the spring seat formed by the magnet armature element inside the receiving recess for the first end of the reset spring, to run and/or be arranged in a lower half of the magnet armature element as seen from the magnet core element, particularly as seen in relation to a maximum total extent of the magnet armature element, preferably a half of the magnet armature element pointing away from the magnet core element. In this way, a particularly stabilizing effect of the reset spring against tilting of the magnet armature element may advantageously be achieved.

The solenoid valve, in particular a 2/2-way solenoid valve, preferably a 2/2-way NC (normally closed) solenoid valve, having the electromagnetic actuator device is furthermore proposed. In this way, in particular, a valve having advantageous valve properties, for example a particularly long service life and/or a particularly low energy requirement, may be achieved. Alternatively, however, it is also conceivable for the solenoid valve having the electromagnetic actuator device to be implemented as a solenoid valve other than a 2/2-way solenoid valve, for example a 3/2-way solenoid valve.

Furthermore, a method for the operation of the electromagnetic actuator device is proposed. In this way, in particular, a valve having advantageous valve properties, for example a particularly long service life and/or a particularly low energy requirement, may be achieved.

The electromagnetic actuator device according to the invention, the solenoid valve according to the invention and the method according to the invention are not in this case meant to be restricted to the application and embodiment described above. In particular, the electromagnetic actuator device according to the invention, the solenoid valve according to the invention and the method according to the invention may have a number of individual elements, structural elements, method steps and units other than a number mentioned herein in order to fulfill a functionality described herein.

### DRAWINGS

Further advantages may be found from the following description of the drawings. The drawings represent an exemplary embodiment of the invention. The drawings, the description and the claims contain many features in combination. A person skilled in the art will expediently also consider the features individually and combine them to form further expedient combinations.

In the figures:

FIG. 1 shows a schematic sectional view of a solenoid valve with an electromagnetic actuator device,

FIG. 2 shows a schematic sectional view of a magnet armature element and a reset spring of the electromagnetic actuator device, and

FIG. 3 shows a schematic flowchart of a method with the electromagnetic actuator device.

### DESCRIPTION OF THE EXEMPLARY EMBODIMENT

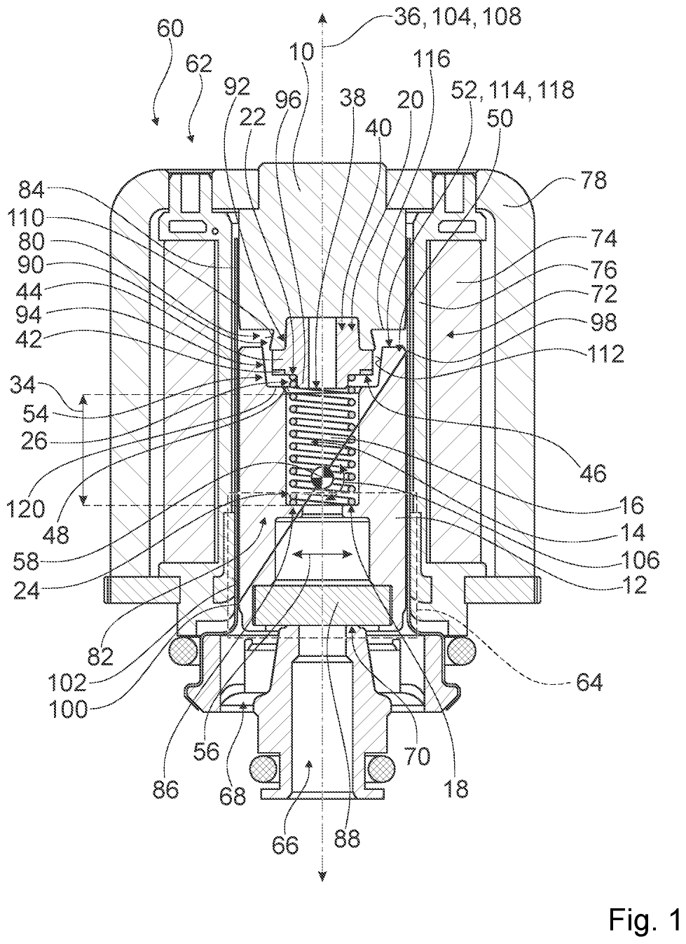

FIG. 1 shows a schematic sectional view of a solenoid valve 60. The solenoid valve 60 is embodied as a 2/2-way NC seated valve. The solenoid valve 60 may, for example, be configured for use in the motor vehicle sector. The solenoid valve 60 comprises a working connection 66. The solenoid valve 60 comprises a supply connection 68. The solenoid valve 60 controls a communication between the working connection 66 and the supply connection 68. The solenoid valve 60 has a valve seat 70. The valve seat 70 is configured to interact with a valve seat element 88 of a magnet armature element 12. The valve seat element 88 is realized as a valve seal. The valve seat element 88 is configured to be seated in a leaktight manner on the valve seat 70. When the valve seat element 88 is seated in a leaktight manner on the valve seat 70, the working connection 66 is closed. When the valve seat element 88 is seated in a leaktight manner on the valve seat 70, a path between the working connection 66 and the supply connection 68 is closed. When the valve seat element 88 is removed from the valve seat 70, the path between the working connection 66 and the supply connection 68 is opened.

The solenoid valve 60 has an electromagnetic actuator device 62. The electromagnetic actuator device 62 is realized as a valve device. The electromagnetic actuator device 62 has a magnet coil 72. The magnet coil 72 is embodied as a hollow coil. The magnet coil 72 comprises a coil carrier element 76. The magnet coil 72 comprises coil windings 74. The coil windings 74 are wound repeatedly around the coil carrier element 76. The magnet coil 72 has an axial direction 36. The axial direction 36 of the magnet coil 72 runs centrally through an interior 82 of the magnet coil 72, in particular through a winding center of the coil windings 74. The electromagnetic actuator device 62 has a magnet core element 10. The magnet core element 10 at least partially forms a magnet core of the electromagnetic actuator device 62. The magnet core element 10 is supported movably relative to the magnet coil 72. The electromagnetic actuator device 62 has a housing 78. The housing 78 encloses at least a large portion of the magnet coil 72. The magnet coil 72 is fixed relative to the housing 78, preferably on the housing 78. The magnet core element 10 is fixed relative to the housing 78, preferably on the housing 78. The magnet core element 10 is arranged at least partially, in particular at least mostly, inside the coil windings 74 of the magnet coil 72. The magnet core element 10 forms an inductor together with the magnet coil 72.

The electromagnetic actuator device 62 has the magnet armature element 12. The magnet armature element 12 has an axial direction 36. The axial direction 36 of the magnet armature element 12 is identical to the axial direction 36 of the magnet coil 72. The magnet armature element 12 is supported movably relative to the magnet core element 10. The magnet armature element 12 is supported movably relative to the magnet coil 72. magnet armature element 12 is supported movably relative to the valve seat 70. The magnet armature element 12 is supported movably along the axial direction 36. The magnet armature element 12 interacts with a magnetic field of the magnet coil 72. The magnet armature element 12 is attracted toward the magnet core element 10 as a function of the magnetic field of the magnet coil 72. The magnet armature element 12 is arranged partly in the interior 82 of the magnet coil 72. The magnet armature element 12 is attracted further into the interior 82 of the magnet coil 72 as a function of the magnetic field of the magnet coil 72. An air gap 80 is formed between the magnet core element 10 and the magnet armature element 12. When the magnetic field of the magnet coil 72 is activated, the magnet armature element 12 tends to reduce an extent of the air gap 80 by movement of the magnet armature element 12 along the axial direction 36. The magnet armature element 12 has the valve seat element 88. The magnet armature element 12 holds the valve seat element 88. The electromagnetic actuator device 62 has a pole tube 84. The pole tube 84 is arranged partially in the interior 82 of the magnet coil 72. The pole tube 84 is aligned parallel to the axial direction 36. The magnet armature element 12 is arranged inside the pole tube 84. The magnet armature element 12 is movable inside the pole tube 84. In the case of an ideal parallel alignment of its axial direction 36 with respect to the axial direction 36 of the magnet coil 72, the magnet armature element 12 Is free of contact with the pole tube 84. Only in the event of (minimal) tilting of the magnet armature element 12 relative to the axial direction 36 of the magnet coil 72 can contact take place between the pole tube 84 and the magnet armature element 12.

The magnet armature element 12 has a receiving recess 14. The magnet armature element 12 forms the receiving recess 14. The receiving recess 14 is aligned parallel to the axial direction 36 of the magnet armature element 12 and/or of the magnet coil 72. The receiving recess 14 passes axially through the magnet armature element 12. The receiving recess 14 comprises a plurality of subregions with different transverse extents/diameters. The valve seat element 88 is arranged in the receiving recess 14. The valve seat element 88 is arranged in a lower portion of the receiving recess 14 as seen from the magnet core element 10. The valve seat element 88 is arranged at an end of the receiving recess 14 and/or of the magnet armature element 12 pointing away from the magnet core element 10. The electromagnetic actuator device 62 has a reset spring 16. The reset spring 16 is represented FIG. 1 in the assembled and preloaded state. In the assembled and preloaded state, the reset spring 16 has a length 34. The reset spring 16 is configured to push the magnet armature element 12 and the magnet core element 10 away from one another. By pushing the magnet armature element 12 and the magnet core element 10 away from one another, the reset spring 16 generates the NC configuration of the solenoid valve 60. The reset spring 16 is arranged in the receiving recess 14. At least in an operation state of the magnet armature element 12 in which the reset spring 16 is maximally relaxed, the reset spring 16 is arranged fully inside the receiving recess 14 of the magnet armature element 12. In FIG. 1, the reset spring 16 is represented in the maximally relaxed state. The reset spring 16 is arranged fully inside the receiving recess 14 of the magnet armature element 12 in all operation states of the magnet armature element 12. The reset spring 16 is embodied as a helical compression spring. The reset spring 16 is preloaded in the receiving recess 14. The reset spring 16 is preloaded in all operation states of the magnet armature element 12.

The magnet armature element 12 has an application face 18 for the reset spring 16. The application face 18 forms a spring seat 86 of the magnet armature element 12. The reset spring 16 has a first end 24 facing toward the magnet armature element 12 and a second end 26 facing toward the magnet core element 10. The reset spring 16 is supported with the first end 24 on the application face 18. The application face 18 is arranged inside the receiving recess 14. The receiving recess 14 forms a subregion with a reduced diameter, which in turn forms the application face 18. The reset spring 16 is supported on the magnet armature element 12 inside the receiving recess 14 of the magnet armature element 12. The application face 18 for the reset spring 16 is arranged in a lower half 64 of the magnet armature element 12 as seen from the magnet core element 10. The application face 18 for the reset spring 16 runs perpendicularly to the axial direction 36 of the magnet armature element 12 in the lower half 64, as seen from the magnet core element 10, of the magnet armature element 12.

The magnet armature element 12 has a theoretical armature rotation point 58. The theoretical armature rotation point 58 is formed by a midpoint of two diametrically opposite outermost contact points 98, 100 of the magnet armature element 12. The two outermost contact points 98, 100 consist of the points on a surface 102 of the magnet armature element 12 at which the magnet armature element 12 first touches the pole tube 84 enclosing the magnet armature element 12 in the circumferential direction, in particular cylindrically, when the magnet armature element 12 is rotated (for example in one of the directions denoted by an arrow 106) from a position in which the axial direction 36 of the magnet armature element 12 and an intended actuation direction 104 of the magnet armature element 12 run parallel. The theoretical armature rotation point 58 lies on a midaxis 108 of the magnet armature element 12. The application face 18 for the reset spring 16, formed by the magnet armature element 12, is arranged below the theoretical armature rotation point 58 as seen from the magnet core element 10. The application face 18 for the reset spring 16, formed by the magnet armature element 12, runs entirely below the theoretical armature rotation point 58 as seen from the magnet core element 10. Alternatively, however, it is also conceivable for the application face 18 for the reset spring 16 to run through the theoretical armature rotation point 58 of the magnet armature element 12.

The electromagnetic actuator device 62 has a control cone 90. The control cone 90 is configured to minimize and/or compensate for transverse magnetic forces that may influence a movement of the magnet armature element 12. The control cone 90 comprises two control cone parts 92, 94. The first control cone part 92 is realized as a portion of the magnet core element 10. The first control cone part 92 is realized as a projection that protrudes annularly from the magnet core element 10 in the direction of the magnet armature element 12. The second control cone part 94 is realized as a portion of the magnet armature element 12. The second control cone part 94 is realized, as seen from the magnet core element 10, as an uppermost portion of the receiving recess 14 which has an increased diameter in comparison with an underlying region that tightly encloses the reset spring 16. The two control cone parts 92, 94 are configured to overlap and/or engage in one another during a movement of the magnet armature element 12 in the direction of the magnet core element 10. The first control cone part 92 has an outer circumferential face, which faces toward the coil windings 74 of the magnet coil 72 and the surface 110 of which is angled relative to the axial direction 36 of the magnet coil 72 or relative to an axial direction 36 of the magnet core element 10. The surface 110 of the first control cone part 92 is angled relative to the axial direction 36 in such a way that the surface 110 approaches the coil windings 74 of the magnet coil 72 when moving further on the surface 110 in the direction of the magnet armature element 12. The second control cone part 94 has an inner circumferential face, which faces toward the reset spring 16 and the surface 112 of which is angled relative to the axial direction 36 of the magnet coil 72 or relative to the axial direction 36 of the magnet armature element 12. The surface 112 of the second control cone part 94 is angled relative to the axial direction 36 in such a way that the surface 112 approaches the coil windings 74 of the magnet coil 72 when moving further on the surface 110 in the direction of the magnet core element 10. With respect to a more detailed description of the effect of this configuration of the control cone 90 providing stabilization against transverse magnetic forces, reference is again made to EP 2 630 647 A2.

The electromagnetic actuator device 62 has a damping element 20. The damping element 20 is arranged between the magnet core element 10 and the magnet armature element 12. The damping element 20 is arranged in the air gap 80. The damping element 20 is configured to prevent contact between the magnet armature element 12 and the magnet core element 10. The damping element 20 is configured to form and/or define an abutment for the movement of the magnet armature element 12. The damping element 20 is configured to damp the braking of the magnet armature element 12 at the end of a movement distance directed toward the magnet core element 10. The damping element 20 forms a spring seat 22 on which a second end 26 of the reset spring 16, lying opposite the first end 24, is supported. The damping element 20 has a spring guiding element 96. The spring guiding element 96 is implemented as a circular elevation of the damping element 20 on a side of the damping element 20 facing toward the reset spring 16. The spring seat 22 of the damping element 20 runs around the spring guiding element 96. The spring guiding element 96 prevents radial slipping of the reset spring 16 in the assembled and preloaded state.

The damping element 20 is arranged in a central region 38 of the magnet armature element 12, lying radially inward as seen relative to the axial direction 36 of the magnet armature element 12. The damping element 20 is arranged in a central region 38 of the magnet core element 10, lying radially inward as seen relative to the axial direction 36 of the magnet core element 10. The magnet core element 10 has a further receiving recess 40, which is configured to receive the damping element 20 in such a way that it is at least substantially secured against radial movements. The magnet core element 10 is fixed in the further receiving recess 40 of the magnet core element 10 by a snug fit or by means of a light press fit. A portion 50 of the magnet armature element 12 lying radially outward is free of covering elements, such as damping elements 20, on a side 52 facing toward the magnet core element 10. An overlap section 54 of the magnet armature element 12, which is configured to enclose at least a portion of the magnet core element 10 in the radial direction 56 in at least one operation state of the magnet armature element 12, is free of covering elements, such as damping elements 20, on at least one side 52 facing toward the magnet core element 10. A portion 114 of the magnet core element 10 lying radially outward is free of covering elements, such as damping elements 20, on a side 116 facing toward the magnet armature element 12. The air gap 80 is free of elements that conduct a magnetic field poorly or not at all, for example damping elements 20, in a region between the parts 50, 114 of the magnet armature element 12 and of the magnet core element 10 that lie radially outward.

The damping element 20 is (in each operation state of the magnet armature element 12) arranged partially in the receiving recess 14. The damping element 20 is movable relative to the magnet armature element 12 inside the receiving recess 14. During a movement of the magnet armature element 12 in the magnetic field of the magnet coil 72, a position of the damping element 20 relative to the magnet armature element 12 changes. During the movement of the magnet armature element 12 in the magnetic field of the magnet coil 72, a position of the damping element 20 in the receiving recess 14 changes. As seen from the magnet core element 10 in the axial direction 36 of the magnet armature element 12, the spring seat 22 of the damping element 20 is arranged below an end of the magnet armature element 12 facing toward the magnet core element 10, in particular below a front side 118 of the magnet armature element 12 facing toward the magnet core element 10.

The damping element 20 is formed partially from an elastomer. The damping element 20 is formed partially from a material other than an elastomer. The damping element 20 is realized as a multi-piece structural element having at least two components 42, 44. Alternatively, the damping element 20 may also be realized as a composite structural element having at least two components 42, 44. The first component 42 of the multi-piece structural element or of the composite structural element is formed from the elastomer. The magnet armature element 12 forms an abutment face 120, which is configured to abut on the damping element 20 at a maximum deflection of the magnet armature element 12. The first component 42 is arranged in a region 46 of the damping element 20 facing toward an abutment face 120 of the magnet armature element 12. The first component 42 forms a shape of an annular disk. The first component 42 is fixed on the second component 44. The first component 42 may be materially bonded (or connected in another way) to the second component 44. The second component 44 of the damping element 20 realized as a multi-piece structural element or as a composite structural element is formed from a material that is substantially harder than the elastomer of the first component 42. The second component 44 of the damping element 20 is arranged in a region 48 of the damping element 20 lying around the spring seat 22 for the reset spring 16.

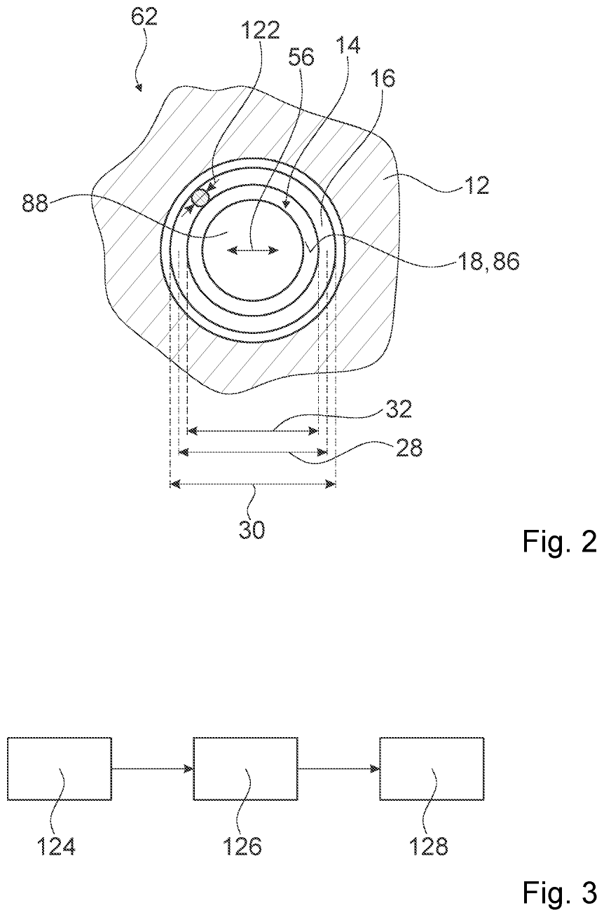

FIG. 2 shows a schematic plan view of a section through the reset spring 16 and of the magnet armature element 12 in a vicinity of the spring seat 86 of the magnet armature element 12. The reset spring 16 has an inner diameter 32. The reset spring 16 has an outer diameter 30. The reset spring 16 has a diameter 28 which is formed from an average value between the outer diameter 30 and the inner diameter 32. The reset spring 16 has a diameter-length ratio of at least 0.35, preferably at least 0.4 and preferentially at least 0.45. In order to calculate the diameter-length ratio, the diameter 28 formed from the average value of the outer diameter 30 and the inner diameter 32 is used. In the maximally relaxed state shown in FIG. 1, the reset spring 16 has a length 34 which is used to calculate the diameter-length ratio. The reset spring 16 is formed from a steel wire. The steel wire has a wire thickness 122. The wire thickness 122 is the difference between the outer diameter 30 of the reset spring 16 and the inner diameter 32 of the reset spring 16. A quotient formed from a length 34 of the reset spring 16 (see FIG. 1) and the wire thickness 122 is more than 0.85, preferably more than 1.0 and preferentially more than 1.1. In the maximally relaxed state shown in FIG. 1, the reset spring 16 has the length 34 which is used to calculate the quotient.

FIG. 3 shows a method for operating the electromagnetic actuator device 62. In at least one method step 124, the magnet coil 72 is kept de-energized. No magnetic force is therefore exerted on the magnet armature element 12, and the reset spring 16 presses the valve seat element 88 onto the valve seat 70. The path between the working connection 66 and the supply connection 68 is closed. In at least one further method step 126, the magnet coil 72 is energized. The magnet armature element 12 is thereby moved in the direction of the magnet core element 10. The path between the working connection 66 and the supply connection 68 is now opened. In the method step 126, transverse magnetic forces that occur are compensated for and/or absorbed at least partially by the reset spring 16 positioned and realized according to the description above. The magnet armature element 12 therefore moves with substantially reduced tilting, that is to say with substantially reduced friction on the pole tube 84. Low-wear and energy-saving operation of the electromagnetic actuator device 62 may therefore be achieved. In at least one further method step 128, the magnetic field of the magnet coil 72 is deactivated again so that the magnet armature element 12 returns into the initial placement of method step 124.

1. An electromagnetic actuator device, in particular an electromagnetic valve device, having at least one magnet core element, having a magnet armature element, which is supported movably relative to the magnet core element and forms a receiving recess, and having a reset spring, which is configured to push the magnet core element and the magnet armature element away from one another, the magnet armature element having an application face, which is arranged inside the receiving recess and on which a first end of the reset spring is supported, comprising a damping element, which is arranged between the magnet core element and the magnet armature element and which forms a spring seat, on which a second end of the reset spring, lying opposite the first end, is supported.

2. The electromagnetic actuator device as claimed in claim 1, wherein the reset spring has a diameter-length ratio of at least 0.35, preferably at least 0.4 and preferentially at least 0.45, a diameter relevant for calculating the diameter-length ratio being formed from an average value of an outer diameter of the reset spring and an inner diameter of the reset spring.

3. The electromagnetic actuator device as claimed in claim 2, wherein a quotient, which is formed from a difference between the outer diameter of the reset spring and the inner diameter of the reset spring and from a length of the reset spring, is more than 0.85, preferably more than 1.0 and preferentially more than 1.1.

4. The electromagnetic actuator device as claimed in claim 1, wherein the damping element is arranged in a central region of the magnet armature element and/or the magnet core element, said central region lying radially inward as seen relative to an axial direction of the magnet armature element and/or of the magnet core element.

5. The electromagnetic actuator device as claimed in claim 1, wherein the damping element is arranged at least partially in the receiving recess.

6. The electromagnetic actuator device as claimed in claim 1, wherein the damping element is movable inside the receiving recess.

7. The electromagnetic actuator device as claimed in claim 1, wherein the magnet core element has a further receiving recess, which is configured to receive the damping element in such a way that it is at least substantially secured against radial movements.

8. The electromagnetic actuator device as claimed in claim 1, wherein as seen from the magnet core element in the axial direction, the spring seat of the damping element is arranged below an end of the magnet armature element facing toward the magnet core element.

9. The electromagnetic actuator device as claimed in claim 1, wherein the damping element is formed at least partially from an elastomer.

10. The electromagnetic actuator device as claimed in claim 9, wherein the damping element is realized as a multi-part structural element having at least two components or as a composite structural element having at least two components, a first component of the multi-piece structural element or of the composite structural element being formed from the elastomer and being arranged at least partially in a region of the damping element facing toward an abutment face of the magnet armature element.

11. The electromagnetic actuator device as claimed in claim 10, wherein a second component of the damping element realized as a multi-piece structural element or as a composite structural element is formed from a material that is substantially harder than the elastomer of the first component and is arranged at least partially in a region of the damping element around the spring seat for the reset spring.

12. The electromagnetic actuator device as claimed in claim 1, wherein a portion of the magnet armature element lying radially outward is free of covering elements, such as damping elements, on at least one side facing toward the magnet core element.

13. The electromagnetic actuator device as claimed in claim 1, wherein at least a large portion of an overlap section of the magnet armature element, which is configured to enclose at least a portion of the magnet core element in the radial direction in at least one operation state of the magnet armature element, is free of covering elements, such as damping elements, on at least one side facing toward the magnet core element.

14. An electromagnetic actuator device, in particular an electromagnetic valve device, having at least one magnet core element, having a magnet armature element, which is supported movably relative to the magnet core element and forms a receiving recess, and having a reset spring, which is configured to push the magnet core element and the magnet armature element away from one another, the magnet armature element having an application face, which is arranged inside the receiving recess and on which a first end of the reset spring is supported, wherein at least in an operation state of the magnet armature element in which the reset spring is maximally relaxed, the reset spring is arranged fully inside the receiving recess of the magnet armature element.

15. An electromagnetic actuator device, in particular an electromagnetic valve device, having at least one magnet core element, having a magnet armature element, which is supported movably relative to the magnet core element and forms a receiving recess, and having a reset spring, which is configured to push the magnet core element and the magnet armature element away from one another, the magnet armature element having an application face, which is arranged inside the receiving recess and on which a first end of the reset spring is supported, wherein the application face for the reset spring runs through the theoretical armature rotation point of the magnet armature element or, as seen from the magnet core element, runs below the theoretical armature rotation point of the magnet armature element.

16. An electromagnetic actuator device, in particular an electromagnetic valve device, having at least one magnet core element, having a magnet armature element, which is supported movably relative to the magnet core element and forms a receiving recess, and having a reset spring, which is configured to push the magnet core element and the magnet armature element away from one another, the magnet armature element having an application face, which is arranged inside the receiving recess and on which a first end of the reset spring is supported, wherein as seen from the magnet core element, the application face for the reset spring runs in a lower half of the magnet armature element.

17. A solenoid valve, in particular a 2/2-way valve, having an electromagnetic actuator device as claimed in claim 1.

18. (canceled)
